(19) United States
(12) Patent Application Publication
(10) Pub. No.: US 2016/0328768 A1
(43) Pub. Date: Nov. 10, 2016

(54) TOWING / VENDOR CONNECTION APPARATUS AND METHOD OF USE THEREOF

(71) Applicants: Rajesh Kumar, Phoenix, AZ (US); Todd DeMasseo, Paradise Valley, AZ (US)

(72) Inventors: Rajesh Kumar, Phoenix, AZ (US); Todd DeMasseo, Paradise Valley, AZ (US)

(21) Appl. No.: 14/706,919

(22) Filed: May 7, 2015

(51) Int. Cl. G06Q 30/06

(52) U.S. Cl. CPC G06Q 30/0619

(57) ABSTRACT

The invention comprises a connection system, implemented as an apparatus and method of use thereof, for linking vehicle towing related information with a service and/or a product provided by a company. The connection system optionally timely provides information about a towed vehicle and/or towing event to a service system where the towing related information is optionally: obtained through a standardized uplink utilized by a set of towing companies; used to develop a towing/services relationship calibration; provided to a probabilistic prediction system; directly related to an incident; related to non-incident vehicle status; related to a specific actor, location, incident, vehicle type, and/or vehicle sub-system; and/or is provided to the service system, such as a retailor or a vendor.

### BACKGROUND OF THE INVENTION

1. Field of the Invention

The invention relates to connecting vehicle towing related information with retailers and/or vendors.

2. Discussion of the Prior Art

### Authorized Access

Modern business operates at tremendous speed where information is often as important or more important than services rendered or products provided.

### Problem

What is needed is a system for enhancing information flow to those in need of products and/or services.

### SUMMARY OF THE INVENTION

The invention comprises a connection system timely linking vehicle towing related information with the service and/or product industry.

### DESCRIPTION OF THE FIGURES

A more complete understanding of the present invention is derived by referring to the detailed description and claims when considered in connection with the Figures, wherein like reference numbers refer to similar items throughout the Figures.

FIG. 1 illustrates a connection system linking towing company information with a service system;

FIG. 2 illustrates a towing data collection system;

FIG. 3 illustrates a calibration system for vehicle towing data;

FIG. 4 illustrates a probabilistic prediction engine system; and

FIG. 5 illustrates a towing information distribution system.

Elements and steps in the figures are illustrated for simplicity and clarity and have not necessarily been rendered according to any particular sequence. For example, steps that are performed concurrently or in different order are illustrated in the figures to help improve understanding of embodiments of the present invention.

### DETAILED DESCRIPTION OF THE INVENTION

The invention comprises a connection system, implemented as an apparatus and method of use thereof, for linking vehicle towing related information with a service, a company, and/or a product of the company.

In one embodiment, the connection system timely provides information related to a towed vehicle and/or a towing event to a service system where the towing related information is optionally: obtained through a standardized uplink utilized by a set of towing companies; used to develop a towing/services relationship calibration; provided to a probabilistic prediction system; directly related to an incident; related to non-incident vehicle status; related to a specific actor, location, incident, vehicle type, and/or vehicle sub-system; and/or is provided to the service system, such as a retailor or vendor. Optionally and preferably, the connection system 140 matches a need, a probable need, and/or a probable want of an actor involved with a towing event with goods, products, and/or services of a company/retailer/vendor 172. The connection system and elements thereof are further described, infra.

Towing Incident/Vendor Connection System

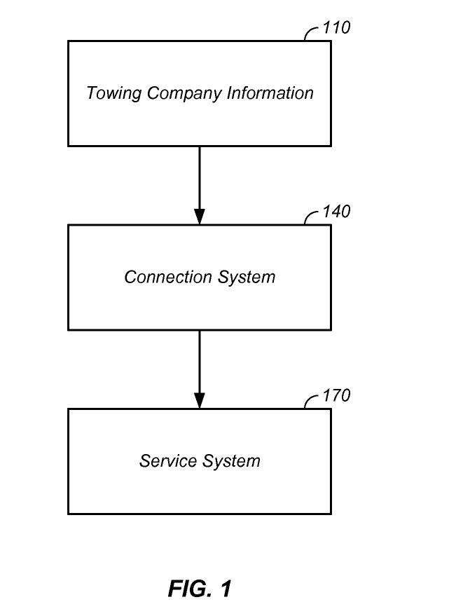

Referring now to FIG. 1, a towing connection system or connection system 140 is illustrated linking towing company information 110 to a service system 170. Herein, for clarity of presentation, the towing company information 110 refers to data and/or information obtained from one or more towing companies and/or one or more towing events. Herein, also for clarity of presentation, the service system 170 refers to a product, a good, and/or a service offered by a retailer, a company, a service provider, and/or a vendor. Generally, the connection system 140 matches needs of an actor involved with a towing event with goods, products, and/or services of the company/retailer/vendor 172. Herein, for clarity of presentation the term actor 270 is used to represent any of: an owner of the vehicle, a driver of the vehicle, a passenger of the vehicle, and/or a person injured by the vehicle. The towing company information 110, connection system 140, and service system 170 are further described, infra.

Towing Company/Connection System Interface

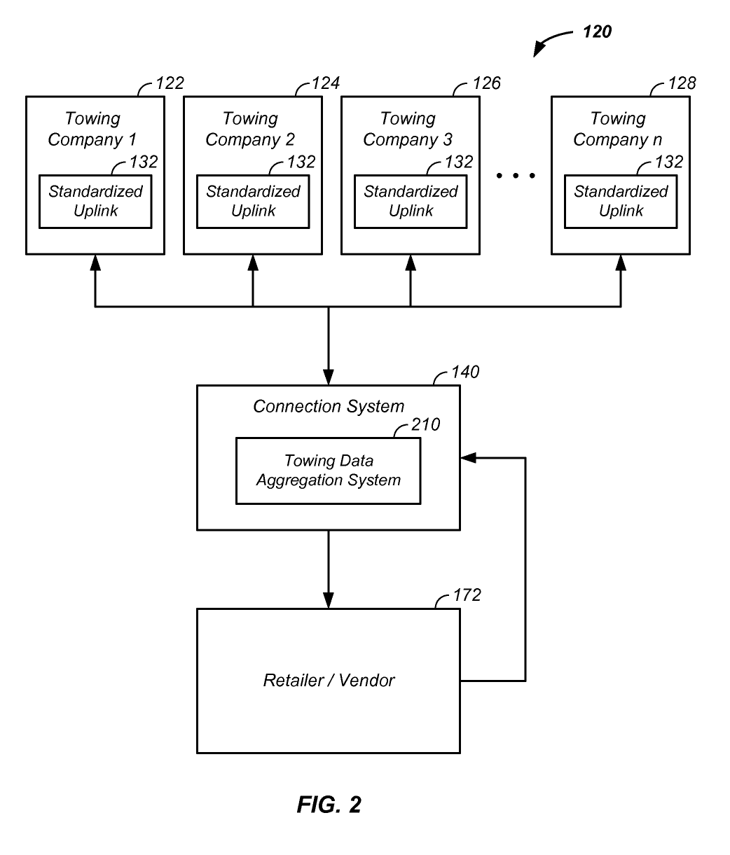

Referring now to FIG. 2, a link between one or more towing companies 120 and the connection system 140 is described. Herein, the towing company information 110 is gathered and/or derived from the one or more towing companies 120, such as a first towing company 122, a second towing company 124, a third towing company 126, and/or an n^{th} towing company 128, where n is a positive integer, such as more than 1, 2, 3, 4, 5, 10, 25, 50, 100, 500, or 1000. Optionally and preferably, a standardized uplink 132 is provided to the one or more towing companies 120. The standardized uplink 132 is optionally hardware and/or software provided to the one or more towing companies 120, such as by an operator/owner of the connection system 140. For example, the standardized uplink 132 uses a software program operating on a laptop, tablet, phablet, and/or phone. The software program is used to collect data related to a towing event, as further described infra. After parsing, matching, summarizing, and/or distilling the information obtained via the standardized uplink 132, the connection system 140 provides a sub-set or all of the information to the company/retailer/vendor 172, which are players in the service system 170. Optionally and preferably, information and/or requests also flow from the company/retailer/vendor 172 to the connection system 140. Matching of the information from the one or more towing companies 120 with the company/retailer/vendor 172 using the connection system 140 is further described, infra.

Towing Data Aggregation System

Referring still to FIG. 2, the connection system 140 organizes information received via the standardized uplink 132 from the one or more towing companies 120 in a towing data aggregation system 210. The incoming data/information is optionally standardized, such as via the standardized uplink 122 or requires processing, such as via a non-standardized uplink optionally used in place of the standardized uplink 122. In either case, the input data to the towing data aggregation system 210 is received from the one or more towing companies 120, such as via a mainframe and/or server; via a workstation, laptop, and/or table; via a physical connection; through wireless communication; and/or through a firewall. The connection system 140 gathers, organizes, synthesizes, aggregates, appends, and/or combines data/information received from the one or more companies 120, such as via the standardized uplink 132. The towing data aggregation system 210 sorts and/or organizes the data from multiple sources into one or more databases contained on one or more physical systems, such as a computer, server, hard drive, physical storage medium, or the like. Organized data from the data aggregation system 210 is passed to one or more sub-systems of the connection system 140 once, periodically, as needed, as requested, and/or continually, as described infra.

Data Processing System

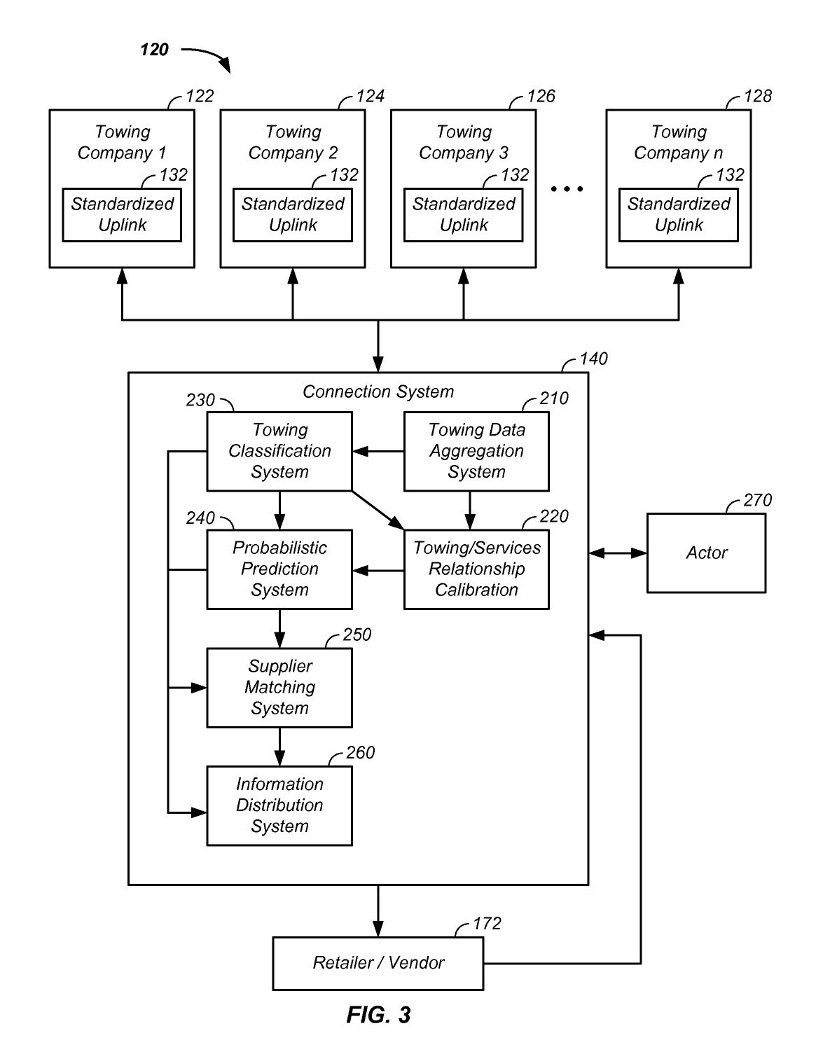

Referring now to FIG. 3, the connection system 140 is further described. Preferably, in a first stage data from the one or more towing companies 120 enters the connection system 140 and passes through the towing data aggregation system 210 to a towing/services relationship calibration module 220, where a calibration module is constructed. In a second stage, data from the one or more towing companies enters the connection system 140 and is passed directly to any of: the towing data aggregation system 210, the towing/services relationship calibration module 220, a towing classification system 230, and/or a probabilistic prediction system 240. In a first example, new information, also referred to as prior information, is fed to the towing data aggregation system 210 and/or the towing/services relationship calibration module 220 to further tailor a calibration model. In a second example, new information is passed directly to a towing classification system 230, described infra. In a third example, new information is passed directly or indirectly to the probabilistic prediction system 240, where a prediction and/or a probabilistic prediction is performed using the calibration model built in the first stage and the new information. The towing classification system 230 and probabilistic prediction system 240 are further described, infra.

Towing Classification System

Still referring to FIG. 3, the towing classification system 230 is further described.

In a first case, the towing classification system 230 is a simplified data processing system with results fed directly to a supplier matching system 250, described infra; an information distribution system 260, described infra; and/or to the company/retailer/vendor 172. For example, the towing classification system 230 classifies the new information into a class, type, cause, and/or problem category. Examples of classification include, but are not limited to: (1) class of vehicle, such as a car, a truck, or a boat; (2) type of vehicle, such as brand, coupe or sedan, vehicle payload, and the like; (3) cause of towing, such as an accident, a dead battery, and/or an authority ordered towing; and/or (4) an identified problem, such as bumper damage, side panel damage, and/or water damage. Each classification narrows probable needs of an actor associated with a particular towing event. For example, the driver of the car may need a taxi ride, a new battery, payment of a fee to recover a vehicle, a new fender, etc. . . . , where information about the need or probable need of the actor is passed to the company/retailer/vendor 172, such as for a fee or as part of a contract obligation.

In a second case, the towing classification system 230 is a preprocessing step, used before development of the calibration model in the towing/services relationship calibration system 220 or use of the probabilistic prediction system 240. Herein, the connection system 140 uses preprocessing or feature extraction to enhance a quality or aspect of the prior information for interpretation. The general purpose of preprocessing is to aid in concise representation of the damage to the vehicle. Preprocessing routines are used to enhance signal, reduce noise, reduce outliers, and/or to simplify or clarify the data. Preprocessing optionally interprets and or reduces an image or video to a type and/or extent of damage of a vehicle and/or a vehicle component. For example, preprocessing a picture or video is used to determine whether the side panel damage is a scratch, a paint chip, a dent, a crumpling, or a total loss. Notably, the preprocessing techniques are used to build more accurate models and to predict more accurately on the prior data, such as to what the actor will want or need as a result of the towing incident and/or what the actor may want or need as a result of a prior state of the vehicle before the towing incident, such as a new seat cover or floor mat as a result of wear and tear on the object.

Calibration/Prediction

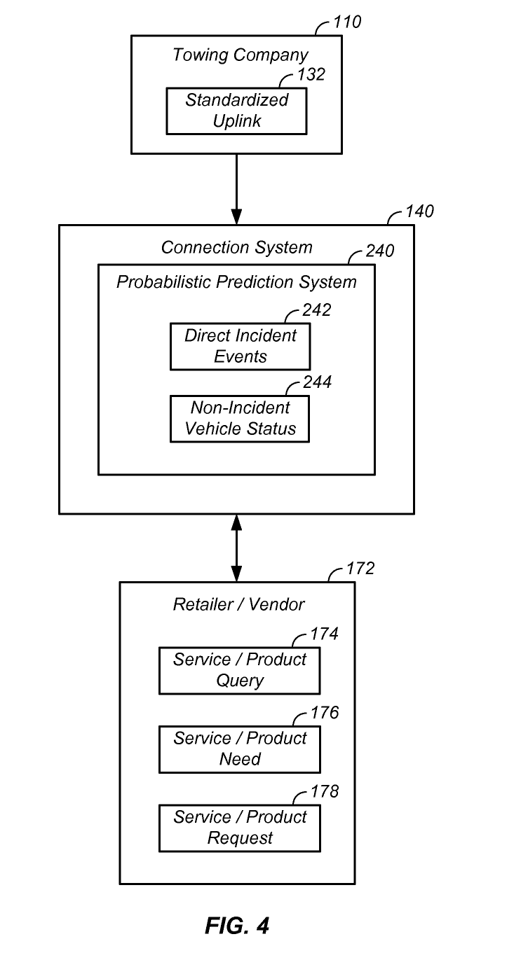

Still referring to FIG. 3 and now referring to FIG. 4, the towing/services relationship calibration module 220 and probabilistic prediction module 240 are further described. Generally, the calibration towing/services relationship calibration module 220 forms one or more calibration models using the organized data from the towing data aggregation system 210. Subsequently, the probabilistic prediction system 240, operating on the new/prior information from a towing event, generates a prediction, such as a need and/or want of the actor, which are optionally matched with a service of a company, such as within less than 5, 10, 15, 30, or 45 minutes, less than 1, 6, 12, and/or 18 hours, and/or in less than 1, 2, 3, 4, or 5 days. Several specific examples are provided herein, without loss of generality, to clarify the invention.

### EXAMPLE I

In a first example, the probabilistic prediction system 240 is fed information about a particular new towing event, such as via the standardized uplink 132, the towing data aggregation system 210, and/or the towing classification system 230.

Subsequently, the probabilistic prediction system 240, optionally using a direct incident events module 242, predicts a need, a want, and/or a desire of an actor of the particular new towing event. For instance, the particular new towing event reveals a broken windshield with relatively little collateral damage to the vehicle and predicts with high certainty that the actor will need a new windshield. Optionally, the supplier matching system 250 is used to match one of more of: a particular windshield needed, a local remote service installation service, and/or a vendor accepting the actor's insurance to the actor's probable need and the information distribution system 260 is used to provide one or more vendors and/or one or more actors 270 with the available service(s). In this example, the probabilistic prediction system 240 matches a need of an actor with a service, where the need is resultant from an incident leading to a particular towing event.

### EXAMPLE II

In a second example, the probabilistic prediction system 240 is fed information about a particular vehicle, such as via the standardized uplink 132, a non-standardized uplink module, the towing data aggregation system 210, and/or the towing classification system 230. However, in this case, a non-incident vehicle status module 244 is used to predict a want and/or need of an actor based upon evidence about a state of the vehicle prior to an incident leading to a particular towing event. For instance, a picture of the odometer used as a prior by the probabilistic prediction system 240 is used to predict, with a lower probability, want for a new vehicle. Another instance is a picture of paint on the vehicle may be used to predict, with a lower probability want, of new paint on the vehicle. In still another instance, rust damage on the vehicle is identified and relayed to to the supplier, such as through the aggregation system. As in the preceding example, optionally, the supplier matching system 250 is used to match the actor's need to one of more of: a car sales facility, a paint shop, and/or a company and the results are optionally relayed to the actor 270 and/or to the company/retailer/vendor 172.

### EXAMPLE III

In a third example, the probabilistic prediction system 240 combines information about a particular towing event with a-priori information to predict an actor want and/or need. For instance, if a high-end automobile is involved in a towing incident, the actor is likely to desire a replacement high end vehicle of the same make or competing make, which is an example of a-priori knowledge. If the towing classification system 230 determines that the towed vehicle was seriously damaged and/or totaled, then the probability of the actor wanting a new vehicle increases. Suppliers of new/replacement vehicles in the actors predicted class and/or in an upgrade class are matched with the actor. In a particular instance, an actor and/or owner of an Audi® AG (Ingolstadt, Bavaria) involved in a towing event is likely to want a replacement Audi® or is likely to be interested in acquiring a Mercedes® (Daimler AG, Stuttgart, Germany) or BMW® (Bayerische Motoren Werke® AG, Munich, Germany). The connection system 140 optionally provides information about the actor and/or the towing incident to a high-end automobile dealer.

In the three examples provided in this section, supra, the probability of an actor's want or need is referred to as high or low. More specifically, a probability and/or a mathematical probability is optionally associated with a prediction from the probabilistic prediction system 240.

Upgrade

An additional example is provided, without loss of generality, to further describe the invention. In this example, the connection system 140 is fed information about a particular vehicle, such as via the standardized uplink 132, a non-standardized uplink module, the towing data aggregation system 210, and/or the towing classification system 230. In this case, the connection system, such as through use of the towing classification sub-system 230, identifies a component of the vehicle that is optionally upgradeable. The identified component is not necessarily damaged. The upgradable component is optionally an element that is out of style and/or is readily replaceable with a component having enhanced performance. The connection system 140 then relays the upgradeable part information, optionally with actor identification and contact information, to the company/retailer/vendor 172.

Goods/Services

Referring still to FIG. 4, the relationship between the connection system 140 and the company/retailer/vendor 172 is further described. The connection system provides to the company/retailer/vendor 172: (1) a service/product query 174, which queries the company about price and/or availability of a particular service or product; (2) a service/product need 176, which is a predicted need of a particular actor, preferably at a particular time and/or place; and/or (3) a service/product request 178, which is a particular request from the actor. Optionally, the company/retailer/vendor 172 provides to the connection system 140 the service/product query 174 to see if the connection system 140 can identify a particular need of an actor that matches the companies services and/or products.

Intelligent System

Still referring to FIG. 4, optionally an intelligent system is used by the connection system 140 to further enhance matching wants or needs of the actor with goods and/or services of a company. The intelligent system is optionally part of the connection system 140 or any module thereof, such as the towing / services relationship calibration module 220, the towing classification system 230, the probabilistic prediction system module 240, and/or the supplier matching system module 250. The intelligent system optionally uses any of:
a classification algorithm;
a decision tree;
a decision list;
a Bayesian classifier;
a neural network;
a genetic algorithm;
a clustering algorithm;
an expert system;
a hierarchical system; and/or
a hierarchical mixture of experts.

The intelligent system is optionally applied to a particular element of a towing incident, as opposed to the entire data set, to enhance a signal-to-noise ratio related to the particular element. The intelligent system optionally uses an image analysis system, such as an automated system used to convert the visual representation of the damage to a report. For example, damage to a headlight or fender shown in a photo is converted by the image processing system to a report of a damaged headlight or fender. Subsequent application of the prediction module 240 is subsequently applied to the narrowed sample element information.

Information Distribution System

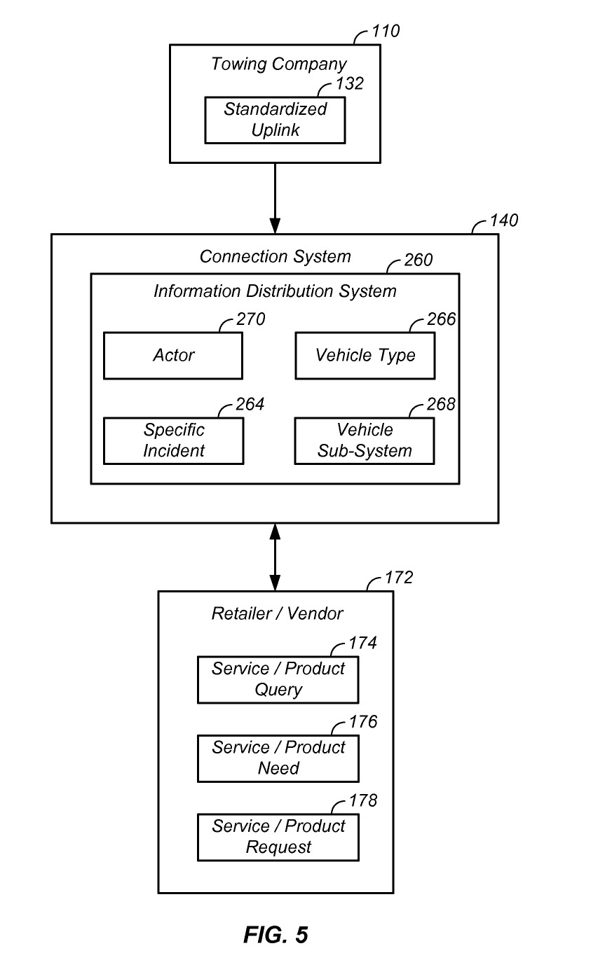

Referring now to FIG. 5, the information distribution system 260 is further described. Generally, the information distribution system 260 distributes to the company/retailer/vendor 172 any information related to a towing event. Without loss of generality, several particular examples include: (1) information about the actor 270, such as contact information; (2) information about the specific incident 264, such as cause of towing; (3) information about the vehicle type 266, such as year, make, model, and/or class; and/or (4) information about a vehicle sub-system 268, vehicle option, and/or vehicle add-on, such existence of an element, lack of existence of an element, and/or condition of the element. Similarly, the connection system 140 optionally and/or additionally uses the information distribution system 260 to disseminate information about matched goods and/or services to the actor 270.

Still referring to FIG. 5, optional elements of the information distribution system 260 are further described. Preferably, the information distribution system 260 reports at least one of: a specific connection, a particular want, a particular need, a specific actor, a heat map of a set of needs, a heat map of a set or wants, a suggested action, an automated communication to a company/service provider, and/or an automated delivery of match information to the actor. Preferably, the automated communication occurs, relative to a particular towing incident, in less than 5, 10, 30, or 45 minutes; less than 1, 2, 6, or 12 hours; and/or in less than 1, 2, 3, 4, or 5 days.

Physical Interface

Still referring to FIG. 5, the information distribution system 260 is optionally an interface to a human user, such as via computer related hardware. The connection system 140 is implemented on one or more computers using physical interface connections, such as a wireless receiver or physical connection, to the vehicle towing event data. The connection system 140 is implemented and stored using one or more computer processors and a form or storage medium, such as a hard drive. The interface is optionally any physical element configured for observing by or interaction by a connection analyst. Examples of physical elements include a computer monitor and a control panel implemented to view at least output of the connection system 140.

Computer

The threat assessment system optionally and preferably uses a system controller, which optionally comprises one or more subsystems stored on a client. The client is a computing platform configured to act as a client device or other computing device, such as a computer, personal computer, a digital media device, and/or a personal digital assistant. The client comprises a processor that is optionally coupled to one or more internal or external input device, such as a mouse, a keyboard, a display device, a voice recognition system, a motion recognition system, or the like. The processor is also communicatively coupled to an output device, such as a display screen or data link to display or send data and/or processed information, respectively. In one embodiment, the system controller is the processor. In another embodiment, the system controller is a set of instructions stored in memory that is carried out by the processor. In still another embodiment, the remote system is the processor.

The client includes a computer-readable storage medium, such as memory. The memory includes, but is not limited to, an electronic, optical, magnetic, or another storage or transmission data storage medium capable of coupling to a processor, such as a processor in communication with a touch-sensitive input device linked to computer-readable instructions. Other examples of suitable media include, for example, a flash drive, a CD-ROM, read only memory (ROM), random access memory (RAM), an application-specific integrated circuit (ASIC), a DVD, magnetic disk, an optical disk, and/or a memory chip. The processor executes a set of computer-executable program code instructions stored in the memory.

The instructions may comprise code from any computer-programming language, including, for example, C originally of Bell Laboratories, C++, C#, Visual Basic® (Microsoft, Redmond, Wash.), Matlab® (MathWorks, Natick, Mass.), Java® (Oracle Corporation, Redwood City, Ccalif.), and JavaScript® (Oracle Corporation, Redwood City, Calif.).

### SUMMARY

Generally, the connection system generates leads and/or connections related to a particular towing event. The connections and/or leads optionally include: information about the actor, time of the event, location of the event, distance of the event from a company site, a probabilistic preference of the actor, damage related to the event, and/or an injury related to the event.

Still yet another embodiment includes any combination and/or permutation of any of the elements described herein.

Herein, a set of fixed numbers, such as 1, 2, 3, 4, 5, 10, or 20 optionally means at least any number in the set of fixed number and/or less than any number in the set of fixed numbers.

The particular implementations shown and described are illustrative of the invention and its best mode and are not intended to otherwise limit the scope of the present invention in any way. Indeed, for the sake of brevity, conventional manufacturing, connection, preparation, and other functional aspects of the system may not be described in detail. Furthermore, the connecting lines shown in the various figures are intended to represent exemplary functional relationships and/or physical couplings between the various elements. Many alternative or additional functional relationships or physical connections may be present in a practical system.

In the foregoing description, the invention has been described with reference to specific exemplary embodiments; however, it will be appreciated that various modifications and changes may be made without departing from the scope of the present invention as set forth herein. The description and figures are to be regarded in an illustrative manner, rather than a restrictive one and all such modifications are intended to be included within the scope of the present invention. Accordingly, the scope of the invention should be determined by the generic embodiments described herein and their legal equivalents rather than by merely the specific examples described above. For example, the steps recited in any method or process embodiment may be executed in any order and are not limited to the explicit order presented in the specific examples. Additionally, the components and/or elements recited in any apparatus embodiment may be assembled or otherwise operationally configured in a variety of permutations to produce substantially the same result as the present invention and are accordingly not limited to the specific configuration recited in the specific examples.

Benefits, other advantages and solutions to problems have been described above with regard to particular embodiments; however, any benefit, advantage, solution to problems or any element that may cause any particular benefit, advantage or solution to occur or to become more pronounced are not to be construed as critical, required or essential features or components.

As used herein, the terms “comprises”, “comprising”, or any variation thereof, are intended to reference a non-exclusive inclusion, such that a process, method, article, composition or apparatus that comprises a list of elements does not include only those elements recited, but may also include other elements not expressly listed or inherent to such process, method, article, composition or apparatus. Other combinations and/or modifications of the above-described structures, arrangements, applications, proportions, elements, materials or components used in the practice of the present invention, in addition to those not specifically recited, may be varied or otherwise particularly adapted to specific environments, manufacturing specifications, design parameters or other operating requirements without departing from the general principles of the same.

Although the invention has been described herein with reference to certain preferred embodiments, one skilled in the art will readily appreciate that other applications may be substituted for those set forth herein without departing from the spirit and scope of the present invention. Accordingly, the invention should only be limited by the Claims included below.

1. A method for linking an actor linked to a towed vehicle and towing related information with a service system, comprising the steps of:
using a connection system to link the actor involved in a towing event with the service system, said connection system comprising the steps of:
collecting towing related information from a vehicle towing company, said step of collecting further comprising the step of:
using a standardized towing information uplink to collect the towing related information;
using a calibration model in a step of probabilistically generating at least one of: (1) a predicted need and (2) a predicted want related to the towing related information;
linking the actor and at least one of the predicted need and the predicted want with the service system.

2. The method of claim 1, the actor comprising at least one of:
a driver of the vehicle;
an owner of the vehicle; and
a passenger in the vehicle.

3. The method of claim 2, the service system comprising at least one of:
a company;
a retailer; and
a vendor.

4. The method of claim 3, further comprising the step of the service system offering at least one of:
a good;
a product; and
a service.

5. The method of claim 4, said step of collecting further comprising the step of:
aggregating towing related information from multiple vehicle towing companies, wherein each of said multiple vehicle towing companies use the standardized towing information uplink.

6. The method of claim 4, said step of collecting towing related information further comprising the steps of:
identifying damage to the vehicle directly related to an incident leading to the towing event;
characterizing an extent of the identified damage.

7. The method of claim 6, said step of identifying further comprising the step of:
converting a digital image of the damage to a report using a computer implemented image analysis system.

8. The method of claim 6, said step of linking further comprising the step of:
proving the actor name, actor contact information, and the identified damage to the service system within thirty minutes of a representative of the towing company arriving at the vehicle.

9. The method of claim 4, said step of collecting towing related information further comprising the steps of:
identifying damage to the vehicle not directly related to damage related to an incident leading to the towing event;
characterizing an extent of the identified damage.

10. The method of claim 9, said connection system gathering, from inspection of the towed vehicle, information on at least one of:
a condition of a floor mat of the vehicle; and
a rust condition of a body element of the vehicle.

11. The method of claim 9, said connection system gathering, from inspection of the towed vehicle, non-towing event related information on at least one of:
a picture of an interior of the vehicle;
a picture of an odometer of the vehicle;
a condition of paint of the vehicle; and
a condition of a windshield of the vehicle.

12. The method of claim 4, said step of collecting towing related information further comprising the steps of:
identifying an upgradable component of the vehicle, the upgradeable component not damaged in an incident leading to the towing event.

13. The method of claim 1, said step of probabilistically generating further comprising the steps of:
identifying a class of the towed vehicle;
identifying related vehicles in the class of the towed vehicle, wherein the predicted want is linked to the related vehicles in a report provided to the service system.

14. The method of claim 1, said step of probabilistically generating further comprising the steps of:
identifying a cause of the towing event, wherein the cause and a probabilistic solution is provided in a report to a service system, the service system previously identified as providing a service for the probabilistic solution.

15. The method of claim 4, said connection system further comprising the step of:
generating a towing event database linking a set of actors respectively related to a set of towing events and associated wants determined using the step probabilistically generating.

16. The method of claim 15, further comprising the steps of:
the connection system accepting a service query from the service system;
the connection system identifying a match of the service query with at least one of: (1) the predicted need and (2) the predicted want in the towing event database.

17. The method of claim 15, further comprising the step of:
charging the service system for providing to the service system a match of the service query with an actor and at least one of: (1) the predicted need and (2) the predicted want.

18. The method of claim 16, further comprising the step of:
the connection system attempting to match the service query with an actor need upon placement of updated information into the towing event database.

19. An apparatus used to link an actor linked to a towed vehicle and towing related information with a service system, comprising:
providing a computer implemented connection system to link the actor involved in a towing event with the service system, said connection system comprising:
a computer implemented module to collect towing related information from a vehicle towing company, said computer implemented module further comprising:
a standardized towing information uplink configured to collect the towing related information;
a probabilistic prediction system configure to use a calibration model to generate a predicted want related to the towing related information;
a communication link configured to link the actor and the predicted want with the service system.
